(19) United States
(12) Patent Application Publication
(10) Pub. No.: US 2007/0010109 A1
(43) Pub. Date: Jan. 11, 2007

(54) Fan and frame thereof

(75) Inventors: Shun Chen Chang, Taoyuan Hsien (TW); Wen Shi Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/366,477

(22) Filed: Mar. 3, 2006

(30) Foreign Application Priority Data
Jul. 6, 2005 (TW) 094122790

(51) Int. Cl. H01R 12/00

(52) U.S. Cl. 439/74

(57) ABSTRACT

A frame is for accommodating a circuit board. The frame includes a housing, a base and at least one supporting element. In this case, the base is disposed in the housing. The base has a bottom portion and a tube portion. A predetermined distance exists between the bottom portion and an end surface of the housing, and the tube portion is connected with the bottom portion. The circuit board is disposed in an accommodating space, and the accommodating space and the tube portion are formed at two opposite sides of the bottom portion. The supporting element is disposed between the housing and the base.

This Non-provisional application claims priority under U.S.C.§ 119(a) on Patent Application No(s). 094122790, filed in Taiwan, Republic of China on Jul. 6, 2005, the entire contents of which are hereby incorporated by reference.

### BACKGROUND OF THE INVENTION

1. Field of Invention

The invention relates to a fan, and in particular to a fan and a frame thereof capable of accommodating a larger number of electronic devices thereon.

2. Related Art

FIG. 1 is a schematic illustration showing a conventional fan. Referring to FIG. 1, the conventional fan 1 has a frame 10 and a fan assembly 20 disposed in the frame 10. The frame 10 has a housing 11 and a base 12. The base 12 is composed of a bottom portion 121 and a tube portion 122, which extends from the center of the bottom portion 121. The tube portion 122 is perpendicular to the bottom portion 121.

The fan assembly 20 has a stator 21, a rotor 22 and a circuit board 23. The circuit board 23 is formed with an opening at the center thereof such that the tube portion 122 of the base 12 can penetrate through the opening and then the circuit board 23 is disposed on the base 12. The stator 21 is disposed on the base 12 and is electrically connected to the circuit board 23. The rotor 22 is coupled to the stator 21 and is relatively rotatable with respect to the stator 21 by the magnetic forces between the rotor 22 and the stator 21.

Currently, fans are designed as being automatically manufactured and having multiple functions, so that the number of electronic elements mounted on the circuit board 23 is increased gradually. However, because of the structure of the conventional bearing system, it is necessary to have an opening at the center of the circuit board 23 to allow the tube portion 122 of the base 12 to penetrate therethrough. As the result, the area of the circuit board 23, in which the electronic elements may be disposed, is reduced and the number of electronic elements on the circuit board 23 is limited thereto.

In addition, after the circuit board 23 is disposed on the base 12, an encapsulant is coated on the circuit board 23 in order to prevent the circuit board 23 from being attacked by moisture, dust or salt-fog in the air, and thus to prevent the electronic elements from being damaged. However, because the stator 21 and the rotor 22 are both disposed on the base 12, the stator 21 and the rotor 22 tend to make difficulties during the procedure of coating encapsulant. It is also difficult to control the position and amount of the encapsulant. Thus, the procedure of coating encapsulant becomes complicated. In addition, because the requirement of the precision of height dimension is very high, it is difficult to control the amount of the encapsulant.

### SUMMARY OF THE INVENTION

In view of the foregoing, the invention is to provide a fan and a frame thereof capable of accommodating a larger number of electronic elements on a circuit board in the fan and satisfying the moisture-proof, salt-fog-proof requirements.

Furthermore, the invention is to provide a fan and a frame thereof having a circuit board on which an encapsulant may be easily coated.

To achieve the above, a frame of the invention is for accommodating a circuit board. The frame includes a housing, a base and at least one supporting element. The base is disposed in the housing and has a bottom portion and a tube portion. The bottom portion is disposed within the housing by a predetermined distance from an end surface of the housing so as to form an accommodating space where is below the bottom portion of the base for containing the circuit board. The tube portion is connected with the bottom portion. The supporting element is disposed between the housing and the base.

To achieve the above, a fan of the invention includes a frame and a fan assembly. In this case, the frame has a housing, a base and at least one supporting element. The base is disposed in the housing and has a bottom portion and a tube portion connected with the bottom portion. The bottom portion is disposed within the housing by a predetermined distance from an end surface of the housing so as to form an accommodating space where is below the bottom portion of the base for containing the circuit board. The supporting element is disposed between the housing and the base. A fan assembly has a rotor, a stator and a circuit board. The stator is disposed at one side of the bottom portion of the base connected with the tube portion, and the rotor is coupled to the stator. The circuit board is disposed in the accommodating space, and the circuit board is electrically connected to the stator.

As mentioned hereinabove, since the bottom portion is disposed within the housing by a predetermined distance from an end surface of the housing so as to form an accommodating space where is below the bottom portion of the base for containing the circuit board, it is necessary to have an opening on the circuit board as the conventional fan structure. Therefore, a larger number of electronic elements can be accommodated on the circuit board having a larger size than the conventional circuit board. Furthermore, the circuit board and the fan assembly are respectively disposed at different sides of the base, so that the stator and the rotor of the fan assembly cannot make difficulties during the procedure of coating encapsulant. In addition, the encapsulant can be directly filled in the accommodating space below the bottom portion in which the circuit board is located, so as to simplify the procedure of coating encapsulant. Moreover, because the circuit board is enclosed by the encapsulant, so that the encapsulant can perfectly prevent the circuit board from being attacked by moisture, dust or salt-fog.

The above objectives and advantages of the present invention will become more readily apparent to those ordinarily skilled in the art after reviewing the following detailed description and accompanying drawings, in which:

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a conventional fan;

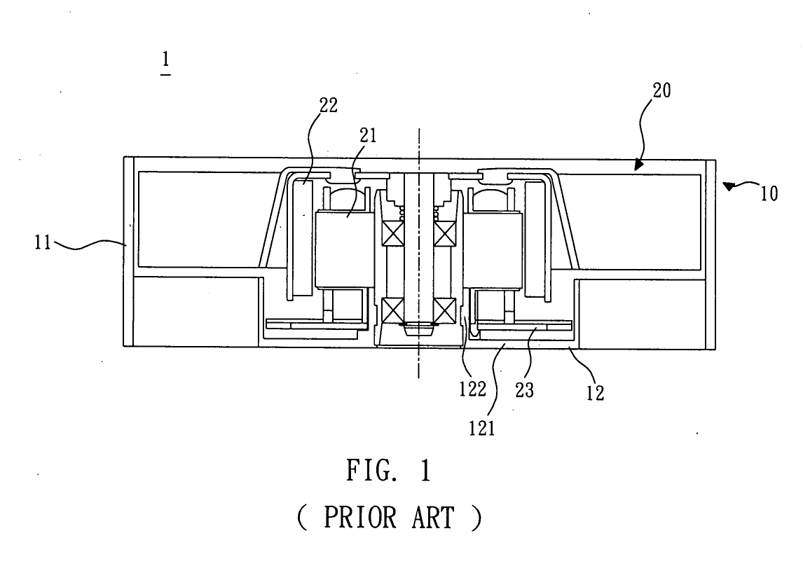

FIG. 2 is a schematic illustration showing a fan of the invention; and

FIG. 3 is a schematic illustration showing another fan of the invention.

### DETAILED DESCRIPTION OF THE INVENTION

The present invention will be apparent from the following detailed description, which proceeds with reference to the accompanying drawings, wherein the same references relate to the same elements.

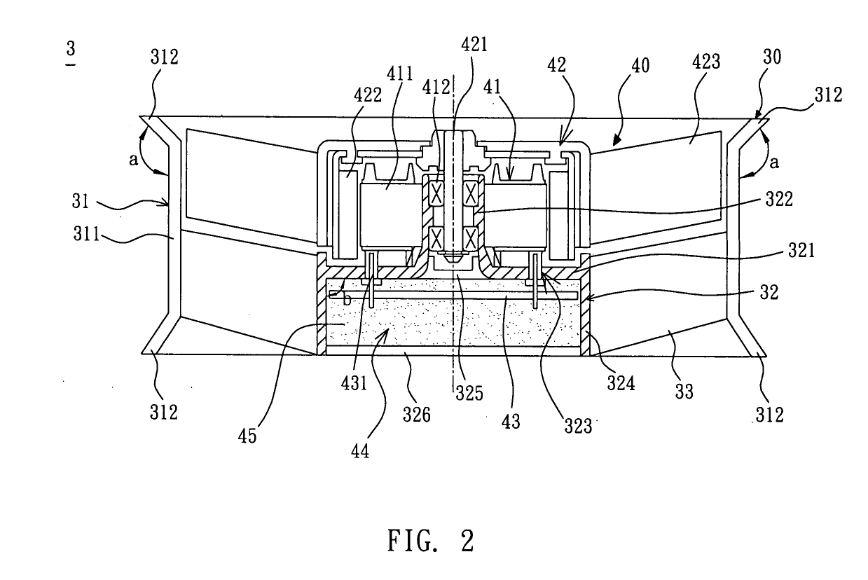

As shown in FIG. 2, a fan 3 according to a preferred embodiment of the invention includes a frame 30 and a fan assembly 40. The frame 30 has a housing 31, a base 32 and at least one supporting element 33. The cross-section of the housing 31 has a substantially circular shape. Of course, the cross-section of the housing 31 may also be substantially rectangular, elliptic or rhomboid according to the actual demand on the product.

The base 32 is disposed in the housing 31, and the base 32 has a bottom portion 321 and a tube portion 322 extending from the center of the bottom portion 321, wherein the tube portion 322 is substantially perpendicular to the bottom portion 321. In addition, the bottom portion 321 is disposed within the housing 31 by a predetermined distance from an end surface of the housing 31 so as to form an accommodating space 44 where is below the bottom portion 321 of the base 32 for containing the circuit board 43. That is, the base 32 is retracted into the housing 31. In this embodiment, the bottom portion 321 of the base 32 further has two through holes 323. Furthermore, the base 32 further has a sidewall 324 disposed around the circumference of the bottom portion 321 of the base 32, and the sidewall 324 and the bottom portion 321 form an angle “b”, which is substantially equal to 90 degrees, as shown in FIG. 2. Of course, the embodiment does not intend to limit the value of the angle “b”, and the angle “b” may be modified according to the actual air-output condition of the fan 3. In addition, the sidewall 324 of FIG. 2 is perferably a plane or a curved surface.

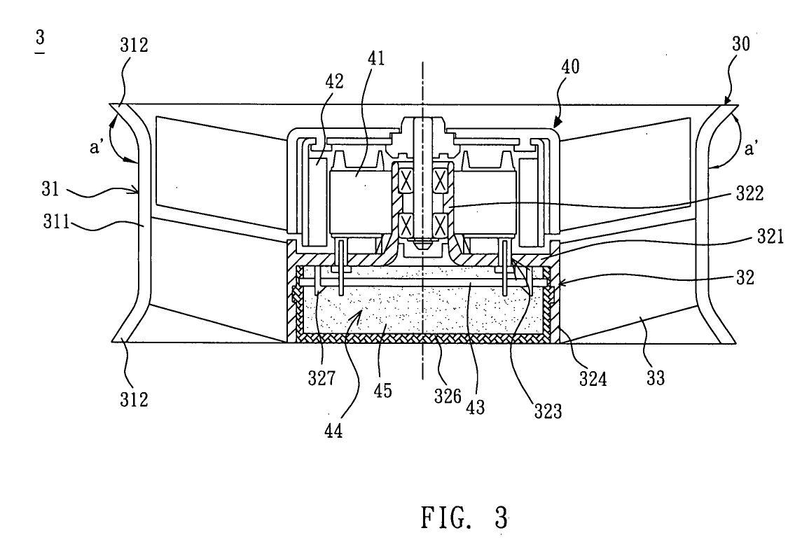

The base 32 may further include a stopper 325 for closing one end of the tube portion 322 which is much closer to the bottom portion 321. The stopper 325 may be an oil seal ring, a packing sheet, a gasket or other equivalent elements. In addition, the base 32 of FIG. 2 further includes a cover plate 326 disposed at one side of the bottom portion 321, which is opposite to the tube portion 322, and the circumference of the cover plate 326 is connected with the sidewall 324. Moreover, the cover plate 326 may have an inverse-U shape and is embedded into the sidewall 324, as shown in FIG. 3. Thus, the accommodating space formed when the base 32 retracts into the housing 31 is closed.

In this embodiment, the housing 31 is formed with a cylindrical passage portion 311 and two external expansion portions 312 respectively disposed at two ends of the passage portion 311. An angle “a” is formed between each external expansion portion 312 and the passage portion 311. The external expansion portions 312 are used for enlarging the area of airflow intake or discharge. Of course, the housing 31 may also be formed with only one external expansion portion 312 at one side of the passage portion 311. The connection between the external expansion portion 312 and the passage portion 311 is formed with the angle “a”, or may be configured to form a lead angle a′ (FIG. 3), an inclined angle, a bevel angle or a large radius angle. That is, even though the shape of the external expansion portion 312 is changed, the external expansion portion 312 with the changed shape should pertain to the scope of the invention as long as it has the effect of enlarging the area of airflow intake or discharge.

As shown in FIGS. 2 and 3, each of the supporting element 33 is disposed between the housing 31 and the base 32, and obliquely extends from the base 32 to the passage portion 311. In this embodiment, the supporting element 33 is a rib. Of course, the supporting element 33 may also be a stationary blade, which is more advantageous to the increasing of airflow intake or discharge.

Referring again to FIG. 2, the fan assembly 40 includes a stator 41, a rotor 42 and a circuit board 43. The stator 41 is disposed at one side of the bottom portion 321 of the base 32 connected with the tube portion 322, and the stator 41 has several coils 411 and two bearings 412. Each coil 411 is disposed adjacent to the tube portion 322, and the bearings 412 are respectively disposed at two sides of the tube portion 322.

The rotor 42 has a rotation shaft 421, a permanent magnet 422 and an impeller 423. The rotation axis 421 of the rotor 42 is coupled to the bearings 412 of the stator 41. Variations of magnetic force are generated between the permanent magnet 422 and the coil 411 of the stator 41 such that the rotor 42 may be relatively rotatable with respect to the stator 41. Consequently, the impeller 423 also rotates to enforce the ambient air to flow such that the fan 3 produces the airflow.

The circuit board 43 is disposed within the accommodating space 44 where is below the bottom portion 321 of the base 32, and the circuit board 43 is electrically connected to the coil 411 of the stator 41. In this embodiment, the circuit board 43 is electrically connected to the coil 411 of the stator 41 by using two pins 431 to respectively pass through two through holes 323 of the base 32. Also, the pins 431 have the function of positioning the circuit board 43 on the base 32. Alternatively, the circuit board 43 may use two wires (not shown) to pass through the through holes 323 so that the circuit board 43 is electrically connected to the stator 41.

In addition to using the pins 431 or the wires to position the circuit board 43 on the base 32, the base 32 may further have two hooks 327, as shown in FIG. 3. Each of the hooks 327 protrudes from and is disposed on the side of the base 32 where the bottom portion 321 is located, so that the hooks 327 can hook and position the circuit board 43. Of course, the circuit board 43 may also be disposed and position on the base 32 by direct contact or in another manner.

As shown in FIGS. 2 and 3, the fan 3 of the embodiment further includes an encapsulant 45, such as a resin or silicon, being coated on the surface of the circuit board 43. The encapsulant 45 can prevent the moisture, dust or salt-fog from attacking the circuit board 43. The encapsulant 45 is directly filled within the accommodating space 44 between the cover plate 326 and the bottom portion 321 of the base 32.

Furthermore, the invention also provides a frame 30 including a housing 31, a base 32 and at least one supporting element 33. The structure of the frame 30 is the same as that disclosed in the above-mentioned embodiment, so the same symbols denote the same elements and detailed description thereof will be omitted.

As mentioned hereinabove, since the bottom portion is disposed within the housing by a predetermined distance from an end surface of the housing so as to form an accommodating space where is below the bottom portion of the base for containing the circuit board, it is necessary to have an opening on the circuit board as the conventional fan structure. Therefore, a larger number of electronic elements can be accommodated on the circuit board having a larger size than the conventional circuit board. Furthermore, the circuit board and the fan assembly are respectively disposed at different sides of the base, so that the stator and the rotor of the fan assembly cannot make difficulties during the procedure of coating encapsulant. In addition, the encapsulant can be directly filled in the accommodating space below the bottom portion in which the circuit board is located, so as to simplify the procedure of coating encapsulant. Moreover, because the circuit board is enclosed by the encapsulant, so that the encapsulant can perfectly prevent the circuit board from being attacked by moisture, dust or salt-fog.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A frame for accommodating a circuit board, comprising:
a housing;
a base disposed in the housing, and including a bottom portion and a tube portion which is connected with the bottom portion, wherein the bottom portion is disposed within the housing by a predetermined distance from an end surface of the housing so as to form an accommodating space for containing the circuit board; and
at least one supporting element disposed between the housing and the base.

2. The frame according to claim 1, wherein the bottom portion has at least one through hole for allowing the circuit board to be electrically connected to an external element.

3. The frame according to claim 1, wherein the base further comprises a sidewall mounted around the bottom portion, and the sidewall and the bottom portion form an angle to control an area of airflow intake or discharge.

4. The frame according to claim 3, wherein the base further comprises a cover plate disposed at one side of the circuit board, which is opposite to the bottom portion, and a circumference of the cover plate is connected with the sidewall.

5. The frame according to claim 1, further comprising an encapsulant filled within the accommodating space.

6. The frame according to claim 5, wherein the encapsulant is resin or silicon.

7. The frame according to claim 1, wherein the base further comprises a stopper for closing an end of the tube portion which is close to the bottom portion.

8. The frame according to claim 1, wherein the housing comprises a passage portion and an external expansion portion which is disposed at one side of the passage portion so as to enlarge an area of airflow intake or discharge.

9. The frame according to claim 8, wherein the supporting element is disposed between the base and the passage portion and obliquely extends from the base to the passage portion.

10. The frame according to claim 8, wherein a connection between the external expansion portion and the passage portion is formed with a lead angle, an inclined angle, a bevel angle or a large radius angle.

11. A fan, comprising:
a frame having a housing, a base and at least one supporting element, the base being disposed in the housing and including a bottom portion and a tube portion which is connected with the bottom portion, wherein the bottom portion is disposed within the housing by a predetermined distance from an end surface of the housing so as to form an accommodating space, and the supporting element is disposed between the housing and the base; and
a fan assembly having a rotor, a stator and a circuit board, wherein the stator is disposed at one side of the bottom portion of the base, the rotor is coupled to the stator, the circuit board is electrically connected to the stator and is disposed within the accommodating space.

12. The fan according to claim 11, wherein the stator has at least one coil, and the bottom portion of the frame has at least one through hole for allowing the circuit board to be electrically connected to the coil of the stator by using at least one wire or pin to pass through the through hole.

13. The fan according to claim 11, wherein the base further comprises at least one hook for holding the circuit board.

14. The fan according to claim 11, wherein the circuit board is disposed on the base by directly contact.

15. The fan according to claim 11, wherein the base further comprises a sidewall mounted around the bottom portion, and the sidewall and the bottom portion form an angle to control an area of airflow intake or discharge

16. The fan according to claim 15, wherein the base further comprises a cover plate disposed at one side of the circuit board, which is opposite to the bottom portion, and a circumference of the cover plate is connected with the sidewall.

17. The fan according to claim 11, further comprising an encapsulant filled within the accommodating space.

18. The fan according to claim 17, wherein the encapsulant is resin or silicon.

19. The fan according to claim 11, further comprising a stopper for closing an end of the tube portion which is close to the bottom portion.

20. The fan according to claim 11, wherein the housing comprises a passage portion and an external expansion portion, which is disposed at one side of the passage portion so as to enlarge an area of airflow intake or discharge.
